(19) United States
(12) Patent Application Publication
(10) Pub. No.: US 2025/0308725 A1
(43) Pub. Date: Oct. 2, 2025

(54) Flat Conductor

(71) Applicant: Yazaki Corporation, Tokyo (JP)

(72) Inventor: Kazuyoshi Kagami, Shizuoka (JP)

(21) Appl. No.: 19/072,128

(22) Filed: Mar. 6, 2025

(30) Foreign Application Priority Data
Mar. 26, 2024 (JP) 2024-049789

(51) Int. Cl. H01B 7/42; H01M 50/503; H01M 50/522; H01M 50/588; H01M 50/59

(52) U.S. Cl. CPC H01B 7/428; H01M 50/503; H01M 50/522; H01M 50/588; H01M 50/59

(57) ABSTRACT

A flat conductor includes an elongated conductive plate material having an end portion in a longitudinal direction and a central portion adjacent to the end portion. A conductor resistance per unit length of at least one end portion in the plate material is lower than a conductor resistance per unit length of the central portion. The flat conductor includes a thermally conductive sheet that connects the end portion and the central portion of the plate material and is made of a material having a higher thermal conductivity than the end portion and the central portion.

### CROSS-REFERENCE TO RELATED APPLICATIONS

This application is based on and claims priority under 35 USC 119 from Japanese Patent Application No. 2024-049789 filed on Mar. 26, 2024, the contents of which are incorporated herein by reference.

### TECHNICAL FIELD

The present disclosure relates to a flat conductor.

### BACKGROUND ART

Recent years have seen a growing demand for flat conductors such as busbars used in battery packs for electric vehicles or under floors of electric vehicles as routing members for large currents, with an increasing number of electric vehicles. Meanwhile, flat conductors generate heat due to a temperature rise caused by resistance during energization, so those having a structure that restricts the temperature rise are preferred. An example of the structure that restricts the temperature rise includes one using a conductor having different cross-sectional areas in a longitudinal direction (for example, see Patent Literature 1). Another example of the structure includes one in which metals having different conductivities are connected in a longitudinal direction and one of the metals which has a higher conductivity is used as a connecting portion with another conductive member, thereby restricting heat generation in the connecting portion (for example, see Patent Literature 2).

### CITATION LIST

### Patent Literature

Patent Literature 1: JP2014-229384A

Patent Literature 2: JP2020-113524A

### SUMMARY OF INVENTION

The structure of Patent Literature 1 is formed by press punching a plate material into a T-shaped conductor plate having an elongated plate-shaped body portion and a plate-shaped bulging portion bulging from the body portion in a width direction orthogonal to a longitudinal direction of the body portion, in which the bulging portion is folded toward the body portion to increase a cross-sectional area of a central portion. Accordingly, the plate material remaining after punching has a T-shaped hole and becomes a waste material that cannot be used for further punching. A yield rate is thus likely to be low since a waste material is produced when manufacturing a component having the structure of Patent Literature 1, which may result in decreased productivity.

In a structure in which metals having different conductivities are joined as in Patent Literature 2, a temperature difference between a part having a high conductivity and a part having a low conductivity is likely to increase during energization, which may make it difficult to restrict a temperature rise of an entire conductor.

The present disclosure is made to solve such a problem, and an object thereof is to provide a flat conductor that can improve productivity while restricting a temperature rise of an entire conductor during energization.

A flat conductor of the present disclosure includes an elongated conductive plate material having an end portion in a longitudinal direction and a central portion adjacent to the end portion. A conductor resistance per unit length of at least one end portion in the plate material is lower than a conductor resistance per unit length of the central portion. The flat conductor includes a thermally conductive sheet that connects the end portion and the central portion of the plate material and is made of a material having a higher thermal conductivity than the end portion and the central portion.

According to the present disclosure, it is possible to provide a flat conductor that can improve productivity while restricting a temperature rise of an entire conductor during energization.

### BRIEF DESCRIPTION OF DRAWINGS

FIG. 1 is a perspective view illustrating a flat conductor according to an embodiment;

FIG. 2 illustrates a thermally conductive sheet in FIG. 1 by a broken line;

FIG. 3 is a side view of FIG. 1;

FIG. 4 illustrates the thermally conductive sheet in FIG. 3 by a broken line;

FIG. 5A is a cross-sectional view taken along a line A-A in FIG. 3, and FIG. 5B is a cross-sectional view taken along a line B-B in FIG. 3;

FIG. 6 is a perspective view illustrating an example of a state in which end portions of the flat conductor in FIG. 1 are unfolded;

FIG. 7 is a perspective view illustrating another example of the state in which the end portions of the flat conductor in FIG. 1 are unfolded;

FIGS. 8A and 8B are cross-sectional views illustrating modifications of the flat conductor according to the present embodiment, and are cross-sectional views of a part corresponding to an A-A cross-section in FIG. 3;

FIG. 9 is a cross-sectional view illustrating a modification of the flat conductor according to the present embodiment, and is a cross-sectional view of a part corresponding to the A-A cross-section in FIG. 3;

FIG. 10 is a perspective view illustrating a modification of the flat conductor according to the present embodiment, in which the thermally conductive sheet is illustrated by a broken line;

FIGS. 11A and 11B are perspective views illustrating a modification of the flat conductor according to the present embodiment, in which the thermally conductive sheet is omitted;

FIG. 12 is a side view illustrating a procedure of a method for manufacturing the flat conductor according to the present embodiment;

FIG. 13 is a side view illustrating a procedure of the method for manufacturing the flat conductor according to the present embodiment; and

FIGS. 14A to 14F are side views illustrating procedures of a method for manufacturing the flat conductor illustrated in FIGS. 11A and 11B, in which the thermally conductive sheet is omitted.

### DESCRIPTION OF EMBODIMENTS

Hereinafter, the present disclosure will be described with reference to a preferred embodiment. The present disclosure is not limited to the embodiment to be described below, and the embodiment can be appropriately changed without departing from the gist of the present disclosure. In the embodiment to be described below, there may be parts in which illustration and description of a part of a configuration are omitted, and it is needless to say that a public or well-known technique is appropriately applied to details of an omitted technique within a range in which no contradiction with contents to be described below would occur.

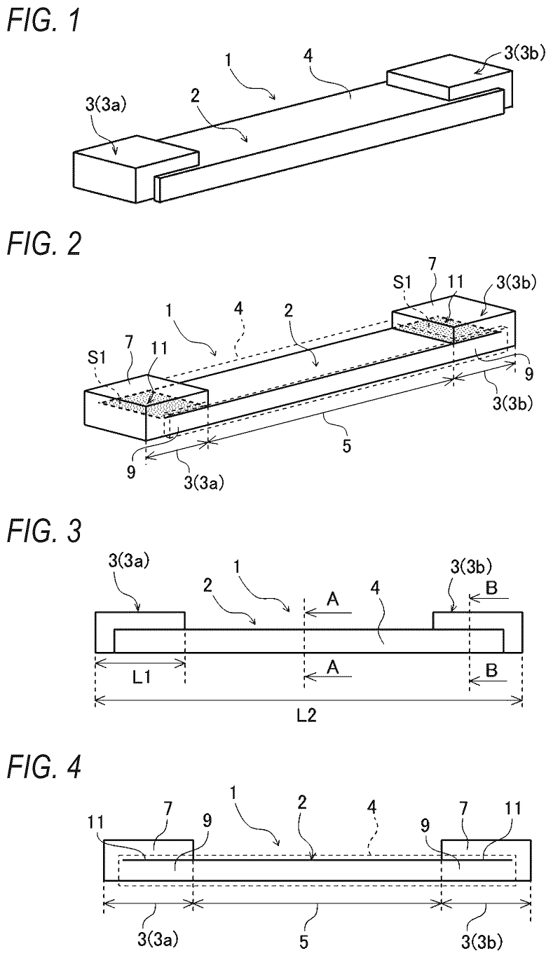

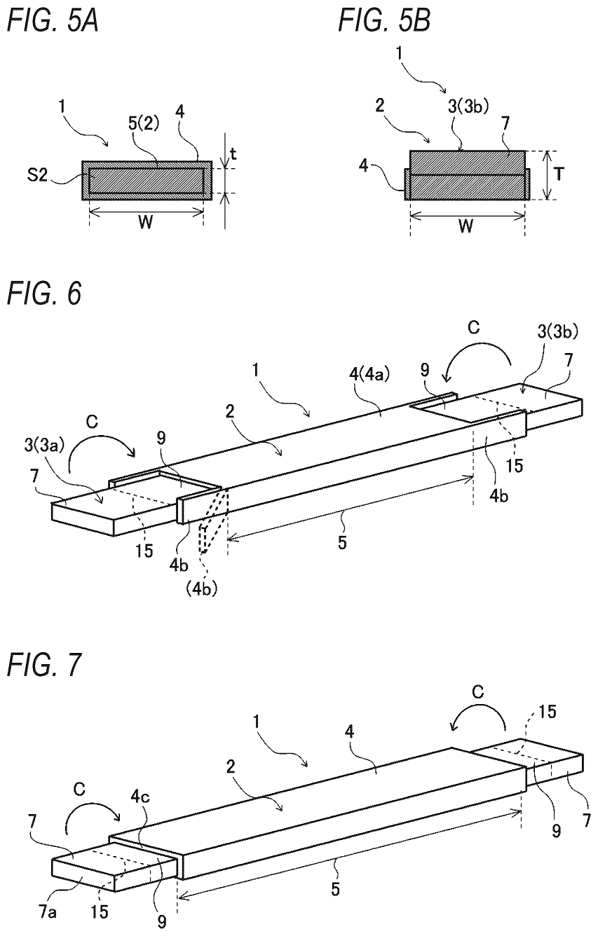

FIGS. 1 to 5B illustrate a flat conductor according to the present embodiment. A flat conductor 1 is, for example, a busbar disposed in a battery pack for an electric vehicle or under a floor of the electric vehicle as a routing member of a battery which is a power source of the electric vehicle, and includes a plate material 2 and a thermally conductive sheet 4. As illustrated in FIGS. 1 to 4, the plate material 2 has an elongated shape. The plate material 2 illustrated in FIGS. 5A and 5B has an A-A cross-section (see FIG. 3) orthogonal to a longitudinal direction, in which a width W is larger than a thickness t. The plate material 2 is conductive. A specific material of the plate material 2 is not particularly limited as long as the plate material 2 is conductive, and may be any one of copper, aluminum, and magnesium due to excellent conductivity, good processability, and not fairly high cost.

As illustrated in FIG. 2, the plate material 2 includes an end portion 3 and a central portion 5. The end portion 3 is a part electrically connected to another conductive member such as a bolt or a terminal, and FIG. 2 illustrates a structure in which the end portion 3 is provided at each of two ends of the plate material 2 in the longitudinal direction. The central portion 5 is a part adjacent to the end portion 3 in the longitudinal direction, here, a part between two end portions 3, and electrically connects both end portions 3 of the flat conductor 1. In the plate material 2, a conductor resistance per unit length in the longitudinal direction of at least one of the end portions 3 in the longitudinal direction, here, both end portions 3, is lower than a conductor resistance per unit length in the longitudinal direction of the central portion 5. As illustrated in FIGS. 2 and 4, the end portion 3 has a more specific structure in which at least one of the two ends of the plate material 2 in the longitudinal direction, here, each of both ends, is folded at least once in a thickness direction and is in surface contact with a part (see a non-folded portion 9 described later) that is not folded. The end portions 3 illustrated in FIGS. 1 to 4 include a left end portion 3a obtained by folding a left end in the longitudinal direction and a right end portion 3b obtained by folding a right end in the longitudinal direction.

The end portion 3 illustrated in FIGS. 2 and 4 includes a folded portion 7 and the non-folded portion 9. The folded portion 7 is a plate-shaped part obtained by folding each of the two ends of the plate material 2. The non-folded portion 9 is a part that is not folded and is in surface contact with the folded portion 7. The end portion 3 illustrated in FIGS. 2 and 4 has a contact surface 11 in which each of the two ends of the plate material 2 is folded once. The contact surface 11 has a U shape due to the folded portion 7 and the non-folded portion 9, and surfaces of the U shape that face each other are in surface contact.

As illustrated in FIGS. 5A and 5B, a thickness T of the end portion 3 is larger than the thickness t of the central portion 5. Since the thickness T of the end portion 3 is larger than the thickness t of the central portion 5, the flat conductor 1 has a larger heat capacity at the end portion 3 than at the central portion 5. For this reason, a temperature of the end portion 3 of the flat conductor 1 is less likely to rise and the end portion 3 can be restricted from generating heat even when, for example, the flat conductor 1 is heated by circuit resistance such as electrical resistance of the plate material 2 or contact resistance between the end portion 3 and another conductive member by connecting the other conductive member to the end portion 3 and energizing the end portion 3. In addition, heat dissipation of the end portion 3 also increases since the part of the end portion 3 which is thicker than the central portion 5 also functions as a radiator. Further, the folded portion 7 and the non-folded portion 9 are integrated into a U shape. For this reason, the folded portion 7 and the non-folded portion 9 are restricted from being displaced from each other even when the plate material 2 vibrates due to a use environment. Thus, it is also possible to restrict an increase in conductor resistance due to separation of the folded portion 7 and the non-folded portion 9 due to vibration. In this manner, the end portion 3 has a structure that can restrict a temperature rise when the flat conductor 1 is energized.

Since the end portion 3 is a part in which at least one of the two ends of the plate material 2 in the longitudinal direction is folded, the end portion 3 can be formed simply by manufacturing the plate material 2 into an elongated shape, cutting the plate material 2 to a length obtained by adding a length of the folded portion 7 to a length required for the flat conductor 1, and folding the end. Therefore, a yield rate of the flat conductor 1 during manufacturing can be improved since it is not necessary to manufacture the plate material 2 by a manufacturing method such as press punching by which a large number of waste materials are produced.

In the end portion 3, the folded portion 7 and the non-folded portion 9 need to be in surface contact with each other to reduce the conductor resistance per unit length. An area S1 of the contact surface 11 defined by surface contact illustrated in FIG. 2 may be larger than a conductor cross-sectional area S2, which is a cross-sectional area of the central portion 5 that is orthogonal to the longitudinal direction as illustrated in FIG. 5A. Since the area S1 of the contact surface 11 is larger than the conductor cross-sectional area S2, there is no concern that the amount of heat generated on the contact surface 11 increases when a current flows through the flat conductor 1.

As the length L1 of the end portion 3 illustrated in FIG. 3 becomes larger, a temperature rise of the end portion 3 during energization can be further restricted, and as the length L1 becomes smaller, the length by which the plate material 2 is folded becomes smaller and the cost decreases. For this reason, the length L1 may be appropriately selected in 30 consideration of a balance between the degree of restriction of the temperature rise during energization and the cost. A total length L2 of the flat conductor 1 illustrated in FIG. 3 may be set according to a distance between another conductive member connected to the left end portion 3a and another conductive member connected to the right end portion 3b. As the width W and the thickness t of the central portion 5 of the plate material 2 illustrated in FIG. 5A and the thickness T of the end portion 3 illustrated in FIG. 5B increase, an effect of restricting a temperature rise of the flat conductor 1 during energization is improved and the strength of the flat conductor 1 increases, and as the width W, the thicknesses t and T decrease, the plate material 2 has a decreased dimension and the cost decreases. For this reason, the width W and the thicknesses t and T may be appropriately selected in consideration of the degree of restriction of the temperature rise during energization, the strength required for the flat conductor 1, and the cost.

The thermally conductive sheet 4 illustrated in FIG. 2 is a sheet-shaped member serving as a heat transfer path between two end portions 3 and the central portion 5, connects the end portions 3 and the central portion 5 of the plate material 2, and is made of a material having a higher thermal conductivity than the end portions 3 and the central portion 5. Specifically, the thermally conductive sheet 4 is attached to a surface of the plate material 2 to connect the end portion 3 and the central portion 5 by, for example, an adhesive or a thermally conductive double-sided tape. Since the flat conductor 1 includes the thermally conductive sheet 4 as described above, the flat conductor 1 has two heat transfer paths between the end portion 3 and the central portion 5, that is, a path through the plate material 2 and a path through the thermally conductive sheet 4. For this reason, a temperature difference between the end portion 3 and the central portion 5 can be further reduced as compared with a case in which no thermally conductive sheet 4 is provided and there is only one path for transferring heat between the end portion 3 and the central portion 5 through the plate material 2. Therefore, it is possible to restrict a temperature rise of the entire flat conductor 1 and heat generation of the flat conductor 1 during energization when, for example, a large current is applied. In particular, heat of the central portion 5 can be transported to the left end portion 3a and the right end portion 3b through the thermally conductive sheet 4 by connecting the left end portion 3a and the right end portion 3b having a low temperature during energization and the central portion 5 having a high temperature during energization with the thermally conductive sheet 4. Therefore, the heat of the entire flat conductor 1 can be made uniform, and the temperature difference in the flat conductor 1 can be reduced. In addition, since the thermally conductive sheet 4 itself serves as a radiator, the thermally conductive sheet 4 itself can also restrict the temperature rise of the flat conductor 1 during energization.

Since the thermally conductive sheet 4 has a sheet shape, the thermally conductive sheet 4 is easily attached to the plate material 2 by being attached to the surface of the plate material 2 and connecting the end portion 3 and the central portion 5 with, for example, an adhesive or a thermally conductive double-sided tape. In addition, since the thermally conductive sheet 4 can be easily attached to the plate material 2, the flat conductor 1 can also be manufactured by attaching the thermally conductive sheet 4 later to an existing conductor without the thermally conductive sheet 4. For this reason, productivity of the flat conductor 1 can be improved.

A specific structure in which the thermally conductive sheet 4 connects the end portion 3 and the central portion 5 is not particularly limited, and examples can include structures illustrated in FIGS. 6 and 7. FIG. 6 is a perspective view illustrating an example of a state in which the end portion 3 of the flat conductor 1 in FIG. 1 is unfolded. FIG. 7 is a perspective view illustrating another example of the state in which the end portion 3 of the flat conductor 1 in FIG. 1 is unfolded. The thermally conductive sheet 4 illustrated in FIG. 6 includes a sheet body 4a that surrounds an outer periphery of the central portion 5, and a protruding portion 4b protruding from each of left and right side ends of the sheet body 4a toward the end portion 3. The protruding portion 4b is in contact with a side face of the end portion 3, and the end portion 3 and the central portion 5 are connected by the thermally conductive sheet 4 via the protruding portion 4b and the sheet body 4a. In the structure illustrated in FIG. 6, the folded portion 7 is folded in the thickness direction as indicated by an arrow C with a connecting portion 15 between the folded portion 7 and the non-folded portion 9 as a fold, and is brought into surface contact with the non-folded portion 9 to form the end portion 3. Further, by attaching the protruding portion 4b to left and right side faces of the end portion 3, the thermally conductive sheet 4 connects the end portion 3 and the central portion 5 via the protruding portion 4b and the sheet body 4a. The folded portion 7 may be folded in a state in which the protruding portion 4b is attached to the side faces of the end portion 3 in advance.

On the other hand, as illustrated in FIG. 7, the thermally conductive sheet 4 may surround the outer periphery of the central portion 5 and include no protruding portion 4b. In the structure illustrated in FIG. 7, a prescribed position of a part of each of two end portions of the plate material 2 in the longitudinal direction which is not covered with the thermally conductive sheet 4 is the connecting portion 15 between the folded portion 7 and the non-folded portion 9. Further, the folded portion 7 is folded in the thickness direction as indicated by the arrow C with the connecting portion 15 as a fold, and is brought into surface contact with the non-folded portion 9 to form the end portion 3. At this time, a top end portion 7a of the folded portion 7 abuts against an end portion 4c of the thermally conductive sheet 4, and thereby the thermally conductive sheet 4 connects the end portion 3 and the central portion 5.

A material and a structure of the thermally conductive sheet 4 are not particularly limited as long as the thermally conductive sheet 4 is a sheet-shaped member having a higher thermal conductivity than the end portion 3 and the central portion 5. An example of a specific material of the thermally conductive sheet 4 can include a graphite sheet. An example of a specific structure of the thermally conductive sheet 4 can include a vapor chamber. The thermal conductivity of the material itself of the thermally conductive sheet 4 may be higher than the thermal conductivity of a material itself of the plate material 2 since the thermally conductive sheet 4 can be reliably used as a heat transfer path between the end portion and the central portion 5. The thermally conductive sheet 4 may further be a conductor since the thermally conductive sheet 4 can also function as an electromagnetic wave shield. A thickness of the thermally conductive sheet 4 may be appropriately selected within a range in which the temperature of the plate material 2 can be reduced to a desired temperature or lower when the flat conductor 1 is energized.

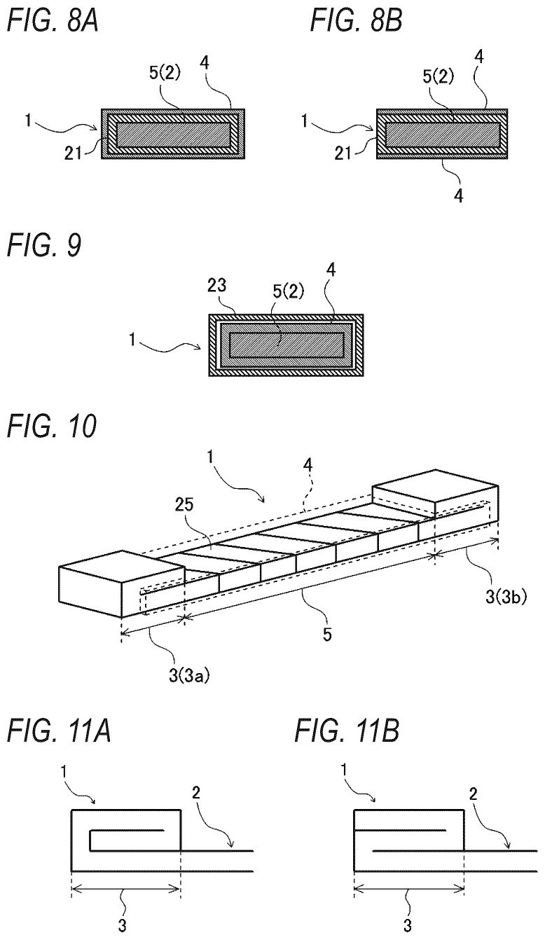

FIGS. 8A and 8B are cross-sectional views illustrating modifications of the flat conductor 1 according to the present embodiment. As illustrated in FIG. 8A, in the flat conductor 1, the surface of the plate material 2 may be covered with an insulator 21. By covering the surface of the plate material 2 with the insulator 21, it is possible to prevent a short circuit due to unintended contact between another surrounding member and the flat conductor 1 and damage to the surface of the plate material 2. FIG. 8A illustrates a case in which the surface of the central portion 5 of the plate material 2 is covered with the insulator 21. Further, not only the surface of the central portion 5 of the plate material 2 but also the surface of the end portion 3 may be covered with the insulator 21.

In the case in which the surface of the plate material 2 is covered with the insulator 21 as illustrated in FIG. 8A, when the thermally conductive sheet 4 is in close contact with the surface of the insulator 21, a part such as an air layer that hinders heat conduction is less likely to occur between the insulator 21 and the thermally conductive sheet 4, and thus the thermal conductivity can be improved. The thermally conductive sheet 4 may be provided only on one of an upper face and a lower face of the central portion 5 (and the end portion 3) as illustrated in FIG. 8B as long as the thermally conductive sheet 4 connects the end portion 3 and the central portion 5 and forms at least a heat transfer path.

FIGS. 9 and 10 illustrate modifications of the flat conductor 1 according to the present embodiment. As illustrated in FIG. 9, the flat conductor 1 may be protected by covering the plate material 2 with a protector 23. As illustrated in FIG. 10, the flat conductor 1 may also be protected by covering the plate material 2 with a tape 25. By protecting the plate material 2, it is possible to prevent damage to the surface of the plate material 2 due to unintended contact with another member. FIGS. 9 and 10 illustrate cases in which the protector 23 and the tape 25 cover the surface of the central portion 5. Further, the protector 23 and the tape 25 may cover not only the central portion 5 but also the end portion 3.

FIGS. 11A and 11B are perspective views illustrating modifications of the flat conductor 1 according to the present embodiment. As illustrated in FIGS. 11A and 11B, the end portion 3 of the flat conductor 1 may have a structure in which each of the two ends of the plate material 2 in the longitudinal direction is folded twice in the thickness direction. In this case, the end portion 3 may have a spiral shape illustrated in FIG. 11A. Alternatively, the end portion 3 may have a corrugated shape (accordion fold) illustrated in FIG. 11B. In this manner, the end portion 3 may be folded twice or more. As the number of folds increases, the thickness T of the end portion 3 illustrated in FIG. 5B can be increased. On the other hand, as the number of folds decreases, the length of the plate material 2 in the longitudinal direction can be reduced, and thus the cost of the flat conductor 1 can be reduced. For this reason, the number of folds may be appropriately selected in consideration of the thickness T required for the end portion 3 and the cost of the flat conductor 1.

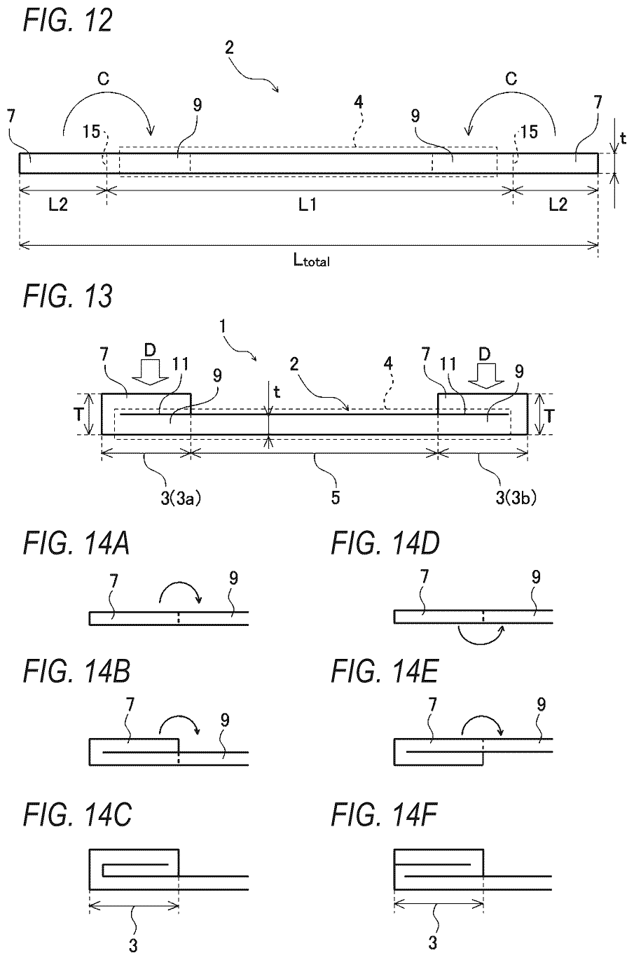

FIGS. 12 to 14 are side views illustrating an example of a method for manufacturing the flat conductor 1. When manufacturing the flat conductor 1, first, as illustrated in FIG. 12, the conductive plate material 2 (see FIG. 5A) is prepared, the conductive plate material 2 having an elongated shape and a cross-section orthogonal to the longitudinal direction in which the width W is larger than the thickness t, and the thermally conductive sheet 4 is attached to the surface of the plate material 2 by an adhesive or a thermally conductive double-sided tape (preparing step). A length Lₜₒₜₐₗ of the plate material 2 in the longitudinal direction illustrated in FIG. 12 may be set by, for example, cutting an elongated member having a desired thickness into a length obtained by adding the length L2 of the folded portion 7 to the length L1 of the flat conductor 1. Since the plate material 2 illustrated in FIG. 12 includes two folded portions 7, Lₜₒₜₐₗ in FIG. 12 is, to be precise, the length L1 plus a value twice L2.

Next, as indicated by the arrow C in FIG. 12, at least one, here both, of the two ends of the plate material 2 are folded at least once in the thickness direction with the connecting portion 15 between the folded portion 7 and the non-folded portion 9 as a fold. Further, as indicated by a white arrow D in FIG. 13, the folded portion 7, which is a folded part, is pressed against and brought into surface contact with the non-folded portion 9, thereby forming a pair of end portions 3 to be electrically connected to other conductive members (folding step). In the folding step, the end portion 3 is formed such that the thickness T of the end portion 3 is larger than the thickness t of the central portion 5 illustrated in FIGS. 5A and 5B and the conductor resistance per unit length of the end portion 3 is lower than the conductor resistance per unit length of the central portion 5. Further, the end portion 3 and the central portion 5 are connected by the thermally conductive sheet 4 in the folding step or the preparing step.

FIGS. 12 and 13 illustrate a case in which each of the two ends of the plate material 2 is folded once. Alternatively, when folded twice, the end portion 3 is formed by procedures illustrated in FIGS. 14A to 14F. Specifically, as illustrated in FIGS. 14A to 14C, the spiral end portion 3 is formed by repeatedly folding each of the two ends to one of an upper face and a lower face of the plate material 2, here, an upper face side. Alternatively, as illustrated in FIGS. 14D to 14F, the corrugated (accordion-fold) end portion 3 is formed by alternately folding each of the two ends to a lower face side and the upper face side.

Hereinafter, the present disclosure will be specifically described based on examples, but the present disclosure is not limited to the examples. Each of the two ends of the plate material 2 in the longitudinal direction was folded to form the end portion 3. A temperature difference between the end portion 3 and the central portion 5 when the flat conductor 1, in which the end portion 3 and the central portion 5 were connected by the thermally conductive sheet 4, was energized was obtained by a computer simulation. This result was compared with a result when the flat conductor 1 was energized without providing the thermally conductive sheet 4. Specific procedures are as follows.

### EXAMPLES

A simulation was performed by following procedures using a heat fluid analysis tool “Ansys Icepak” manufactured by ANSYS. First, a model of the aluminum plate material 2 having a thickness of 5 mm, a width of 24 mm, and a length of 500 mm was prepared, and the two ends of the plate material 2 in the thickness direction were accordion folded twice, each end having a length of 40 mm, so that the thickness T of the end portion 3 was 15 mm. A conductor resistance per unit length of the central portion 5 of the model of the plate material 2 was 0.236 mΩ/m, and a conductor resistance per unit length of the end portion 3 was 0.079 mΩ/m. Next, as the thermally conductive sheet 4, a vapor chamber having a thickness of 0.3 mm was attached to the model of the prepared plate material 2 by a thermally conductive double-sided tape to manufacture a model of the flat conductor 1 in which the end portion 3 and the central portion 5 were connected. Further, a temperature in a center position of the end portion 3 in the longitudinal direction and a width direction and a temperature in a center position of the central portion 5 in the longitudinal direction and the width direction were calculated in a state in which a temperature of the flat conductor 1 was constant by applying a direct current of 800 A to the model of the manufactured flat conductor 1. Specifically, the temperatures were calculated by a temperature monitoring function in Ansys Icepak. As a result, the temperature of the end portion 3 was 163.3° C., and the temperature of the central portion 5 was 170.6° C. The temperature difference between the end portion 3 and the central portion 5 was 7.3° C.

### COMPARATIVE EXAMPLES

A model was produced under conditions of the example except that no thermally conductive sheet 4 was attached to the plate material 2. The temperature in the center position of the end portion 3 in the longitudinal direction and the width direction and the temperature in the center position of the central portion 5 in the longitudinal direction and the width direction when the current was applied to the model under conditions of the example were calculated by the temperature monitoring function in Ansys Icepak. As a result, the temperature of the end portion 3 was 169.2° C., and the temperature of the central portion 5 was 189.5° C., both of which were higher than those in the example. The temperature difference between the end portion 3 and the central portion 5 was 20.3° C., and the temperature difference was larger than that in the example.

From the above results, it is found that by connecting the end portion 3 and the central portion 5 with the thermally conductive sheet 4, the temperature difference in the flat conductor 1 can be reduced as compared with the case in which no thermally conductive sheet 4 is provided, and a temperature rise of the entire flat conductor 1 can be restricted.

In this manner, the flat conductor 1 according to the present embodiment includes the conductive plate material 2, in which the conductor resistance of the end portion 3 is lower than the conductor resistance of the central portion 5, and the thermally conductive sheet 4 that connects the end portion 3 and the central portion 5 and has a higher thermal conductivity than the end portion 3 and the central portion 5. With this configuration, the flat conductor 1 has two heat transfer paths between the end portion 3 and the central portion 5 including a path through the plate material 2 and a path through the thermally conductive sheet 4. For this reason, the temperature difference between the end portion 3 and the central portion 5 can be reduced as compared with the case in which no thermally conductive sheet 4 is provided, and a temperature rise of the entire flat conductor 1 during energization can be restricted, and thus heat generation due to the temperature rise can also be restricted. The temperature rise of the flat conductor 1 can be further restricted since the thermally conductive sheet 4 itself functions as a radiator. Since the thermally conductive sheet 4 has a sheet shape, the end portion 3 and the central portion 5 can be easily connected by attaching the thermally conductive sheet 4 to the plate material 2 by an adhesive or the like, and the thermally conductive sheet 4 can be attached to an existing conductor later. For this reason, the productivity of the flat conductor 1 can be improved.

The end portion 3 of the flat conductor 1 is a part formed by folding, in the thickness direction, each of the two ends of the plate material 2 in the longitudinal direction, and it is not necessary to use a manufacturing method by which a large number of waste materials are produced such as press punching. For this reason, the flat conductor 1 has a high yield rate during manufacturing of the plate material 2, and the productivity can be improved.

Although the present disclosure has been described above based on an embodiment, the present disclosure is not limited to the above embodiment, and modifications may be made without departing from the gist of the present disclosure and other techniques may be appropriately combined if possible. Further, public or well-known techniques may be combined if possible.

For example, in the above-described embodiment, the end portion 3 is provided by folding each of the two ends of the plate material 2 in the longitudinal direction. Alternatively, when it is sufficient to restrict a temperature rise of only one of the two ends of the plate material 2 in the longitudinal direction, the end portion 3 may be provided by folding only one of the two ends of the plate material 2 in the longitudinal direction.

In addition, the left end portion 3a and the right end portion 3b of the end portion 3 are illustrated with the same thickness T in the above-described embodiment. Alternatively, the thickness T of the left end portion 3a and the thickness T of the right end portion 3b may be different when required heat capacities of the left end portion 3a and the right end portion 3b are different.

Further, in the above-described embodiment, the thermally conductive sheet 4 is disposed on the insulator 21 covering the plate material 2. Alternatively, the thermally conductive sheet 4 may be disposed on the plate material 2 and covered with the insulator 21.

What is claimed is:

1. A flat conductor including an elongated conductive plate material having an end portion in a longitudinal direction and a central portion adjacent to the end portion, a conductor resistance per unit length of at least one end portion in the plate material being lower than a conductor resistance per unit length of the central portion, the flat conductor comprising:
a thermally conductive sheet that connects the end portion and the central portion of the plate material and is made of a material having a higher thermal conductivity than the end portion and the central portion.

2. The flat conductor according to claim 1, wherein
a thermal conductivity of the thermally conductive sheet is higher than a thermal conductivity of the plate material.

3. The flat conductor according to claim 1, wherein
a surface of the plate material is covered with an insulator, a protector, or a tape to be protected.

4. The flat conductor according to claim 1, wherein
the plate material is one of copper, aluminum, and magnesium.

5. The flat conductor according to claim 1, wherein
the plate material has a surface covered with an insulator, and
the thermally conductive sheet is in close contact with a surface of the insulator.
